(19) United States
(12) Patent Application Publication
(10) Pub. No.: US 2023/0182362 A1
(43) Pub. Date: Jun. 15, 2023

(54) CONTROLLER FOR INJECTION MOLDING MACHINE AND PROGRAM

(71) Applicant: FANUC CORPORATION, Minamitsuru-gun, Yamanashi (JP)

(72) Inventor: Kensuke NAMIKI, Yamanashi (JP)

(21) Appl. No.: 17/925,955

(22) PCT Filed: Jun. 4, 2021
(86) PCT No.: PCT/JP2021/021422

§ 371 Date: Nov. 17, 2022

(30) Foreign Application Priority Data
Jun. 5, 2020 (JP) 2020-098592

(51) Int. Cl. B29C 45/78; B29C 45/74

(52) U.S. Cl. CPC B29C 45/78; B29C 45/74; B29C 2945/7604; B29C 2945/76531; B29C 2945/76668

(57) ABSTRACT

A controller for an injection molding machine having a heater and serving to estimate the surface temperature of the heater at a predetermined time, the controller comprising: an operation information acquiring unit for acquiring, as operation information, heater output power and heater setting temperature of the heater during a predetermined period immediately before the predetermined time; a surface temperature acquiring unit for acquiring the surface temperature of the heater during the predetermined period; an actual performance information acquiring unit for acquiring, as actual performance information, the actual performance on the transition of the ratio between the surface temperature of the heater and the setting temperature relative to the transition of the heater output power of the heater; and an estimating unit for estimating the surface temperature of the heater at the predetermined time on the basis of the operation information, the actual performance information, and the acquired surface temperature.

### TECHNICAL FIELD

The present disclosure relates to controller and program for an injection molding machine.

### BACKGROUND ART

Typically, an injection molding machine has been known, in which pellets injected into a hopper are melted in a barrel and are injected into a mold. Heaters are arranged at the outer periphery of the barrel of the injection molding machine. The heaters heat the barrel, thereby melting the pellets.

It is useful for monitoring a heater state and calculating a heat dissipation quantity to monitor the surface temperature of the heater. Thus, installation of a temperature measurement sensor on the surface of the heater, temperature measurement by thermography, surface temperature estimation according to an equation, etc. have been performed. For example, as surface temperature estimation according to the equation, a display device has been proposed, in which a surface temperature of the heater is calculated based on a heater operation command value and a temperature detection value from a temperature sensor (see, e.g., Patent Document 1).

Patent Document 1. PCT International Publication No. WO2008/149742

### DISCLOSURE OF THE INVENTION

### Problems to be Solved by the Invention

In surface temperature estimation according to the equation, temperatures at optional positions in barrel axial and radial directions are estimated using temperatures at temperature control points, detection points of additional sensors, etc. An actual barrel has holes for sensors, splits, etc. For this reason, the surface temperature of the barrel is not uniform. Thus, there is a probability that an error occurs between the estimated temperature and an actual temperature. For these reasons, the accuracy of the estimated surface temperature of the heater is suitably improved.

### Means for Solving the Problems

(1) The present disclosure relates to a controller an in e Lion molding machine including a barrel and a heater arranged around the barrel, the controller being configured to estimate the surface temperature of the heater at a predetermined time. The controller includes an operation information acquisition unit that acquires, as operation information, a heater output of the heater and a set temperature for the heater in a predetermined period immediately before the predetermined time, a surface temperature acquisition unit that acquires the surface temperature of the heater in the predetermined period included in the acquired operation information, a results information acquisition unit that acquires, as results information, a results of a transition in the ratio of the surface temperature of the heater to the set temperature for the heater in association with a transition in the heater output of the heater, and an estimation unit that estimates the surface temperature of the heater at the predetermined time based on the operation information, the results information, and the acquired surface temperature.

(2) The present disclosure relates to a program causing a computer to function as a controller for an injection molding machine including a barrel and heaters arranged around the barrel, the controller being configured to estimate the surface temperature of the heater at a predetermined time. The program causes the computer to function as an operation information acquisition unit that acquires, as operation information, a heater output of the heater and a set temperature for the heater in a predetermined period. immediately before the predetermined time, a surface temperature acquisition unit that acquires the surface temperature of the heater in the predetermined period included in the acquired operation information, a results information acquisition unit that acquires, as results information, a results or a transition in the ratio of the surface temperature of the heater to the set temperature for the heater in association with a transition in the heater output of the heater, and an estimation unit that estimates the surface temperature of the heater at the predetermined time based on the operation information, the results information, and the acquired surface temperature.

### Effects of the Invention

According to the present disclosure, the controller and program for the injection molding machine can be provided, which are capable of improving the accuracy of the estimated surface temperature of the heater.

### BRIEF DESCRIPTION OF THE DRAWINGS

FIG. 1 is a schematic view showing an injection molding machine including a controller according to one embodiment of the present disclosure;

FIG. 2 is a table showing one ex mole of results information learned by the controller of one embodiment;

FIG. 3 is a block diagram showing the configuration of the controller of one embodiment;

FIG. 4 is a schematic view showing one example of operation information of the controller of one embodiment;

FIG. 5 is a schematic view showing one example of results information of the controller of one embodiment;

FIG. 6 is a view showing a screen displayed on a display unit of the controller of one embodiment;

FIG. 7 is a flowchart showing the flow of operation of the controller of one embodiment;

FIG. 8 is a view showing a screen displayed on a display unit of a controller of a variation;

FIG. 9 is a view showing a screen displayed on a display unit of a controller of another variation; and

FIG. 10 is a view showing a screen displayed on a display unit of a controller of yet another variation.

### PREFERRED MODE FOR CARRYING OUT THE INVENTION

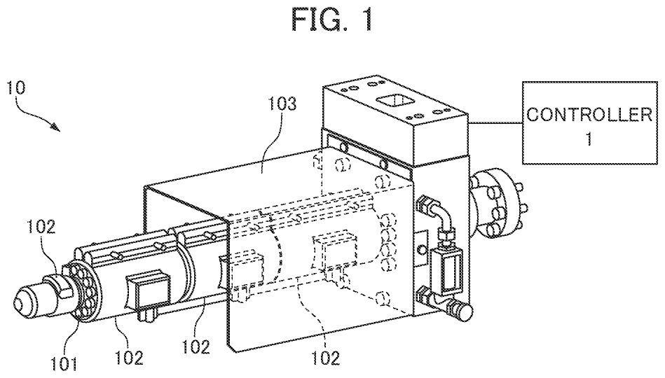

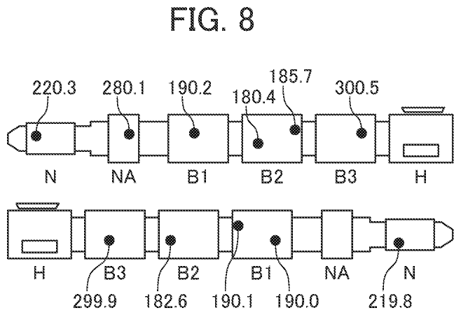

Hereinafter, controller 1 and program for an injection molding machine according to one embodiment of the present disclosure will be described with reference to FIGS. 1 to 10. First, the injection molding machine controlled by the present embodiment will be described. The injection molding machine 10 is a device that performs molding in such a manner that pellets are melted and injected into a mold (not shown). The injection molding machine 10 includes, for example, a barrel 101, heaters 102, and a safety cover 103, as shown in FIG. 1.

The barrel 101 for example, a tubular body. One end portion of the barrel 101 in an axial direction thereof is narrowed toward an end. The barrel 101 has, along the axial direction, screw (not shown) inside. The screw stirs the melted pellets while moving the melted pellets) one end side of the barrel 101.

The heaters 102 are arranged around the barrel 101. The plurality of heaters 102 is, for example, arranged along the axial direction of the barrel 101. Specifically, the plurality or heaters 102 is arranged from a nozzle portion of a tip end to a base end of the barrel 101 in the axial direction thereof. In the present embodiment, five heaters 102 are arranged al on the axial direction so as to cover the outer periphery of the barrel 101. The heaters 102 heat, for example, the barrel 101 to 200 degrees Celsius or higher.

The safety cover 103 is a recessed body arranged around the heaters 102. The safety cover 103 is arranged for avoiding contact with the heaters 102 at a relatively high temperature.

According to the above described injection molding machine 10, the pellets are melted inside the barrel 101 heated to 200 degrees Celsius or higher by the heaters 102. The screw injects the melted pellets into the mold from one end of the barrel 101. In this manner, the injection molding machine 10 molds, example, a plastic product.

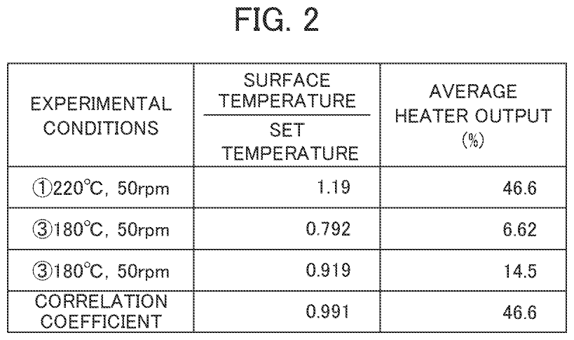

Since the safety cover 103 is arranged around the heaters 102, the surface temperature of the heater 102 cannot be easily directly measured from the outside. It has been found that an actual surface temperature of the heater 102, a set temperature for the heater 102, and the heater output of the heater 102 correlate with each other. Specifically, it has been found that the average heater output of the heaters 102 and the ratio of the surface temperature of the heater 102 to the set temperature for the heater 102 correlate with each other. For example, as shown in FIG. 2, the set temperature for the heater 102 and the rotation number of the screw were set to 220 degrees Celsius and 50 rpm, (2) 180 degrees Celsius and 00 rpm, and (3) 180 degrees Celsius and 50 rpm. As a result, values of Surface Temperature/Set Temperature were 1.19, 0.792, and 0.919, and values of the average heater output were 46.6%, 6.62%, and 14.5%. As a result, the correlation coefficient between Surface Temperature/Set Temperature and the heater output was 0.991. Thus, it has been found that there is a high correlation between Surface Temperature/Set Temperature and the heater output. Note that in an embodiment below, the heater output will be described as a command value for instructing an operation amount of the heater 102 from a controller (not shown) that controls the heater 102. The controller sets, as one example, the command. value based on a detection value at a temperature control point.

The controller 1 for the injection molding machine 10 according to the embodiment below estimates, using the above-described correlation, the surface temperature of the heater 102 from the outside. With this configuration, the controller 1 for the injection molding machine 10 according to the embodiment below more accurately estimates the surface temperature of the heater 102 as compared to estimation of the surface temperature of the heater 102 according to an equation from the temperature control points, detection points of additional sensors, etc. Note that in the embodiment below, “in operation” indicates a moment in which the injection molding machine 10 is actually operating. Moreover, in the embodiment below, a “predetermined time” indicates a time targeted for estimation of the surface temperature of the heater 102.

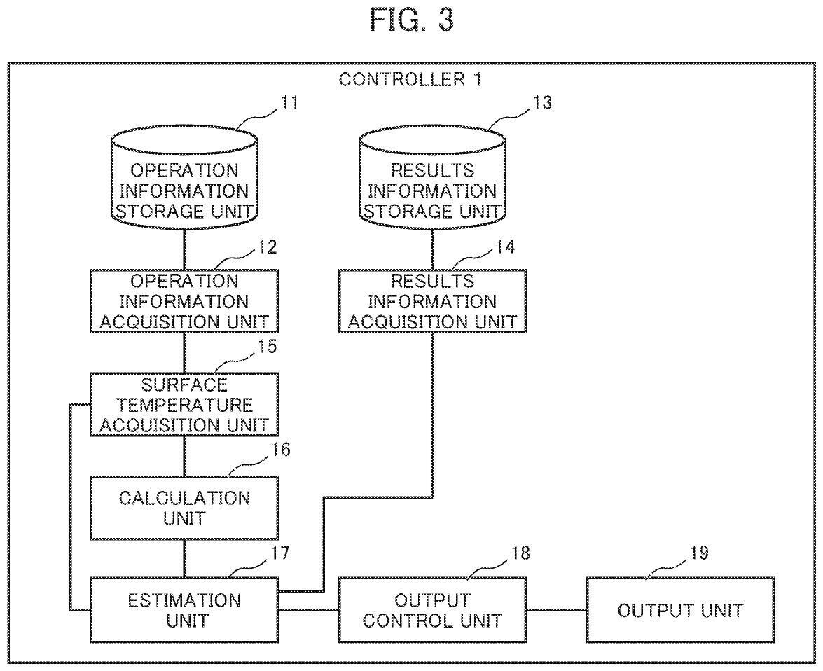

Next, the controller 1 for the injection molding machine 10 according to one embodiment of the present disclosure will be described with reference to FIGS. 1 to 7. The controller 1 is a device that controls the injection molding machine 10. Specifically, the controller 1 is a device that controls conditions for molding by the injection molding machine 10. The controller 1 is, for example, connected to the injection molding machine 10 as shown in. FIG. 1. The controller 1 controls specified molding conditions such as a speed and a pressure in injection molding, the temperature of the barrel 101, a mold temperature, and the amount of melted pellets to be injected. The controller 1 in the present embodiment can also estimate the surface temperature of the heater 102 at the predetermined time. As shown in FIG. 3, the controller 1 includes an operation information storage unit 11, an operation information acquisition unit 12, a results information storage unit 13, a results information acquisition unit 14, a surface temperature acquisition unit 15, a calculation unit 16, an estimation unit 17, an output unit 18, and an output control unit 19.

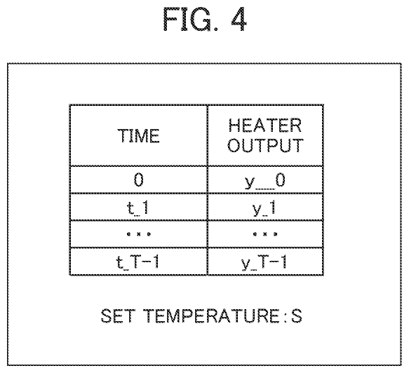

The operation information storage unit 11 is, for example, a storage medium such as a hard disk. The operation information storage unit 11 stores operation information regarding the set temperature for the heater 102 of the injection molding machine 10 and the heater output of the heater 102 in operation. Moreover, the operation information storage unit 11 stores, as the operation information, the contents of instructions regarding operation of the injection molding machine 10, for example. The operation information storage unit 11 stores, for example, the above-described molding conditions as the operation information. For example, as shown in FIG. 4, the operation information storage unit 11 stores heater outputs y_0, y_1, . . . , y_T−1 in every sampling cycle t_1(s) until a point t_T−1 immediately before the predetermined time, assuming that an operation start point is 0 and the predetermined time is T. Moreover, the operation information storage unit 11 stores S (° C.) as the set temperature.

The operation information acquisition unit 12 is, for example, implemented by operation of a CPU. The operation information acquisition unit 12 acquires, as the operation information, the heater output of the heater and the set temperature for the heater in a predetermined period immediately before the predetermined time. In the present embodiment, the operation information acquisition unit 12 acquires the operation information from the operation information storage unit 11. For example, the operation information acquisition unit 12 acquires, as the operation information, the heater output of the heater 102 and the set temperature for the heater 102 in a period from the start of operation of the injection molding machine 10 to a point immediately before the predetermined time. The operation information acquisition unit 12 acquires, for example, the heater output in a preset sampling cycle until a point immediately before the predetermined time.

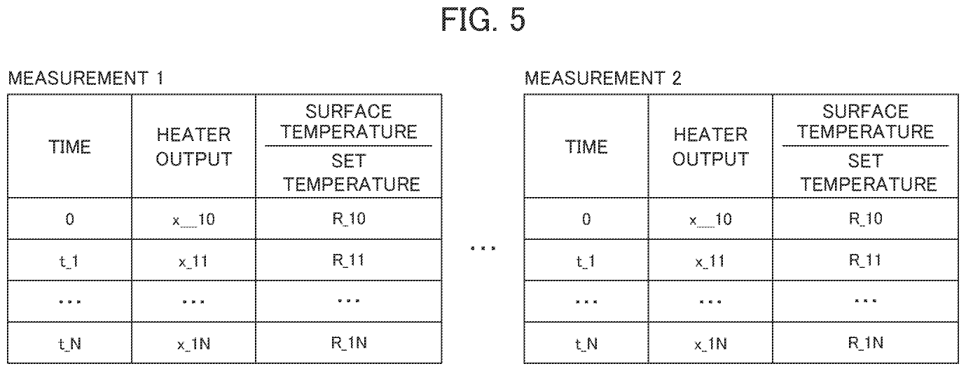

The results information storage unit 13 is, for example, a storage medium such as a hard disk. The results information storage unit 13 stores, as results information, a results of a transition in the ratio of the surface temperature of the heater 102 to the set temperature for the heater 102 in association with a transition the heater output of the heater 102. For example, by taking the transition in the heater output of the heater 102 measured in advance as input data, the results information storage unit 13 stores, as the results information, the transition, which is measured, at the same time as input of the heater output transition, in the ratio (Surface Temperature/Set Temperature) of the surface temperature of the heater 102 to the set temperature for the heater 102. The results information storage unit 13 stores the results information obtained in advance by learning which takes the heater output as input and uses teaching data. Using temperature sensors (not shown) provided in advance so as to contact the surface of the heater 102, the results information storage unit 13 may store, for example, the results information obtained by learning of the relationship between the heater output and the surface temperature as shown in FIG. 2. The results information storage unit 13 stores, for example, a plurality of results as the results information. For example, as shown in FIG. 5, the results information storage unit 13 stores, for each measured results, the results information including a heater output value of x_MN and a Surface Temperature/Set Temperature value of R_MN, assuming that a measurement number is M (M is a natural number), a measurement start time (an operation start time) is 0, and the acquisition time of the heater output is tM_N (N is a natural number).

The results information acquisition unit 14 is, for example, implemented by operation of the CPU. The results information acquisition unit 14 acquires the results information from the results information storage unit 13. For example, the results information acquisition unit 14 acquires, as the results information, the results of the transition in the ratio of the surface temperature of the heater 102 to the set temperature for the heater 102 in association with the transition in the heater output of the heater 102. Specifically, the results information acquisition unit 14 acquires, for each previous heater output, the ratio (Surface Temperature/Set Temperature) of a previous surface temperature to a previous set temperature as the results information.

The surface temperature acquisition unit 15 is, for example, implemented by operation of the CPU. The surface temperature acquisition unit 15 acquires the surface temperature of the heater 102 in a predetermined period included in the acquired operation information. The surface temperature acquisition unit 15 acquires, for example, a surface temperature estimated by the later-described estimation unit 17 in the predetermined period included in the acquired operation information. Alternatively, the surface temperature acquisition unit 15 acquires, instead of the estimated surface temperature, a surface temperature actually measured or provided from the outside. The surface temperature acquisition unit 15 acquires, for example, a surface temperature TP_A (° C.) (A=1, 2, . . . t−1) in every sampling cycle t_1.

The calculation unit 16 is, for example, implemented by operation of the CPU. Based on the acquired operation information and the acquired surface temperature, the calculation unit 16 calculates the transition in the ratio of the surface temperature to the set temperature in association with the transition in the heater output included in the operation information. The calculation unit 16 calculates, for example, the value of Surface Temperature/Set Temperature for each heater output included in the operation information. In the present embodiment, the calculation unit 16 calculates (TP_A/S) (A=1, 2, . . . , t−1) in every sampling cycle t_1.

The estimation unit 17 is, for example, implemented by operation of the CPU. Based on the operation information, the results information, and the acquired surface temperature, the estimation unit. 17 estimates the surface temperature of the heater 102 at the predetermined time. Specifically, the estimation unit. 17 estimates the surface temperature at the predetermined time by means of the operation information and a results similar to or coincident with the calculated ratio transition among the results included in the results information. The estimation unit 17 estimates the surface temperature at the predetermined time from the ratio, which is indicated by the results similar to or coincident with the transition, of the surface temperature to the set temperature at a time corresponding to the predetermined time. For example, the estimation unit 17 specifies, from the results information, a results similar to or coincident with the transition in the heater output and the transition in the ratio of the surface temperature to the set temperature in the operation information indicating a preset period a point immediately before the predetermined time. The estimation unit 17 acquires the ratio of the surface temperature to the set temperature at a subsequent time (corresponding to the predetermined time) after a lapse of the period included in the specified similar or coincident results. Then, the estimation unit 17 multiplies the acquired ratio by the set temperature included in the operation information, thereby estimating the surface temperature at the predetermined time. Note that the estimation unit 17 estimates the surface temperature at the predetermined time by using, e.g., a results having the highest rate of match (e.g., a kappa coefficient) with the transition as the results similar to the transition.

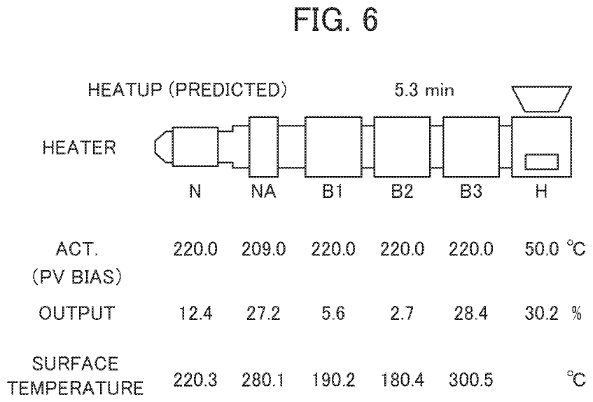

The output unit 18 is, for example, a display unit such as a display. The output unit 18 outputs the estimated surface temperature to the outside. For example, as shown in FIG. 6, the output unit 18 displays the positions of the heaters 102 relative to the barrel 101, the set temperature, the heater output, and a current surface temperature.

The output control unit 19 is, for example, implemented by operation of the CPU. The output control unit 19 causes the output unit 18 to output the estimated surface temperature.

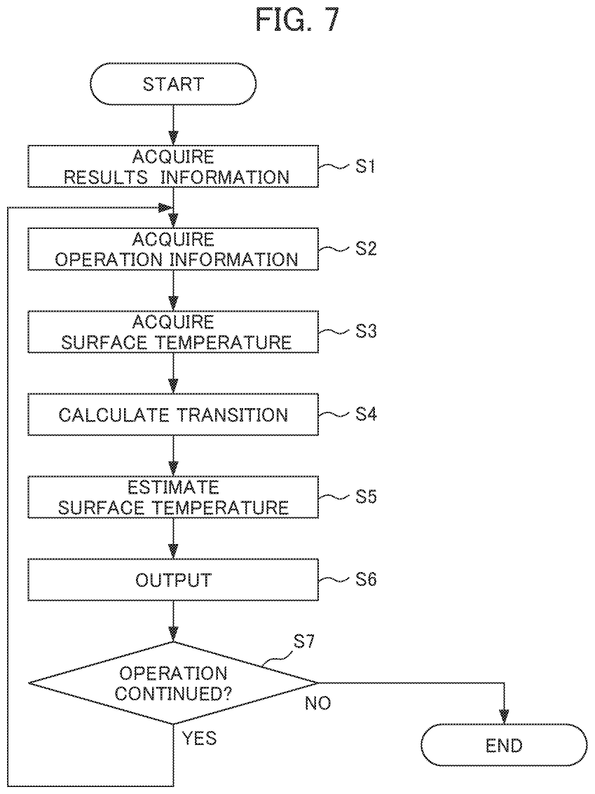

Next, the flow of processing by the controller 1 will be described with reference to FIG. 7. First, the results information acquisition unit 14 acquires the results information (Step S1). The results information acquisition unit 14 acquires, for example, plural pieces of results information from the results information storage unit 13.

Subsequently, the operation information acquisition unit 12 acquires the operation information (Step S2). The operation information acquisition unit 12 acquires, for example, the operation information stored in advance in the operation information storage unit 11.

Subsequently, the surface temperature acquisition unit 15 acquires the surface temperature corresponding to the operation information (Step S3).

Subsequently, the calculation unit 16 calculates, based on the acquired operation information and the acquired surface temperature, the transition in the ratio of the surface temperature to the set temperature in association with the transition in the heater output included in the operation information (Step S4). Subsequently, the estimation unit 17 estimates the surface temperature of the heater 102 from the operation information, the surface temperature, and the results information (Step S5).

In Step 56, the output control unit 19 outputs the estimated surface temperature to the output unit 18. The output unit 18 displays, for example, the estimated surface temperature.

Subsequently, it is determined whether the estimation of the surface temperature is to be repeated or not (Step S7). If the estimation is to be repeated (Step S7: YES), the processing returns to Step S2. On the other hand, if the estimation ends (Step S7: NO), the processing flow ends.

Next, the program of the present embodiment will be described. Each configuration included in the controller I for the injection molding machine 10 may be implemented by hardware, software, or a combination thereof. Implementation by software as described herein means implementation by reading and execution of a program by a computer.

The program can be stored using various types of non-transitory computer readable medium and be supplied to the computer. The non-transitory computer readable medium include various types of tangible storage medium. Examples of the non-transitory computer readable medium include magnetic storage medium (e.g., a flexible disk, a magnetic tape, and a hard disk drive), magnetic optical storage medium (e.g., a magnetic optical disk), a CD-read only memory (CD-ROM.), a CD-R, a CD-R/W, and semiconductor memories (e.g., a mask ROM, a programmable ROM (PROM.), an erasable PROM (EPROM), a flash ROM, and a random access memory (RAM)). The program may be supplied to the computer via various types of transitory computer readable medium. Examples of the transitory computer readable medium include an electric signal, an optical signal, and an electromagnetic wave. The transitory computer readable medium can supply the program to the computer via a wired communication path such as an electric wire or an optical fiber or a wireless communication path.

According to the controller 1 and program for the injection molding machine 10 according to one embodiment as described above, the following advantageous effects are produced.

(1) The controller 1 for the injection molding machine 10 including the barrel 101 and the heaters 102 arranged around the barrel 101 for estimating the surface temperature of the heater 102 at the predetermined time includes the operation information acquisition unit 12 that acquires, as the operation information, the heater output of the heater 102 and the set temperature for the heater 102 in the predetermined period immediately before the predetermined time, the surface temperature acquisition unit 15 that acquires the surface temperature of the heater 102 in the predetermined period included in the acquired operation information, the results information acquisition unit 14 that acquires, as the results information, the results of the transition in the ratio of the surface temperature of the heater to the set temperature for the heater in association with the transition in the heater output of the heater, and the estimation unit 17 that estimates the surface temperature of the heater at the predetermined time based on the operation information, the results information, and the acquired surface temperature. The program causing the computer to function as the controller 1 for the injection molding machine 10 including the barrel 101 and the heaters 102 arranged around the barrel 101 for estimating the surface temperature of the heater at the predetermined time includes instructions that cause the computer to function as the operation information acquisition unit 12 that acquires, as the operation information, the heater output of the heater 102 and the set temperature for the heater 102 in the predetermined period immediately before the predetermined time, the surface temperature acquisition unit 15 that acquires the surface temperature of the heater 102 in the predetermined period included in the acquired operation information, the results information acquisition unit 14 that acquires, as the results information, the results of the transition in the ratio of the surface temperature of the heater 102 to the set temperature for the heater 102 in association with the transition in the heater output of the heater 102, and the estimation unit that estimates le surface temperature of the heater 102 at the predetermined time based on the operation information, the results information, and the acquired surface temperature. With this configuration, the accuracy of the estimated surface temperature of the heater 102 can be further improved regardless of the outer shape (asperities) or the barrel 101. physical sensors, etc. do not need to be placed on the surface of the heater 102, and therefore, cost can be reduce. Thus, the heat dissipation quantity from the surface of the heater 102 to the air can be more accurately calculated. As a result, operation or a molding condition for minimizing the heat dissipation quantity is set so that the life of the heater can be extended and power f r the injection molding machine can be saved.
(2) The controller 1 for the injection molding machine 10 further includes the calculation unit 16 that calculates, based on the acquired operation information and the acquired surface temperature, the transition in the ratio of the sur ace temperature to the set temperature in association with the transition in the heater output included in the operation information. The estimation unit 17 estimates the surface temperature at the predetermined time by means of the operation information and the results similar to or coincident with the calculated ratio transition among the results included in the results information. With this configuration, the heater output and the set temperature are acquired so that the surface temperature can be easily estimated.
(3) The surface temperature acquisition unit 15 acquires the surface temperature of the heater 102 in the form of the ratio of the surface temperature of the heater 102 to the set temperature for the heater 102, and the estimation unit 17 estimates the surface temperature at the predetermined time by means of the operation information and the results similar to or coincident with the acquired ratio transition among the results included in the results information. With this configuration, the ratio of the surface temperature to the set temperature is directly acquired so that the surface temperature can be easily estimated.
(4) The estimation unit 17 estimates the surface temperature at the predetermined time from the ratio, which is indicated by the results similar to or coincident with the transition, of the surface temperature to the set temperature at a time corresponding to the predetermined time. With this configuration, the surface temperature is estimated based on the previous results so that the accuracy of the estimated surface temperature can be improved.

Each preferred embodiment of the controller and program for the injection molding machine according to the present disclosure has been described above, but the present disclosure is not limited to the above-described embodiments and can be modified as necessary. For example, in the above-described embodiments, the output control unit 19 may cause the output unit 18 to display the surface temperatures of the heaters 102 and measurement positions upon learning of the results information as shown in 8. The results information storage unit 13 stores the results information including the measurement positions. The estimation unit 17 estimates the surface temperature of the heater 102 for each measurement value included in the results information. With this configuration, visibility of the surface temperature of the heater 102 can be improved.

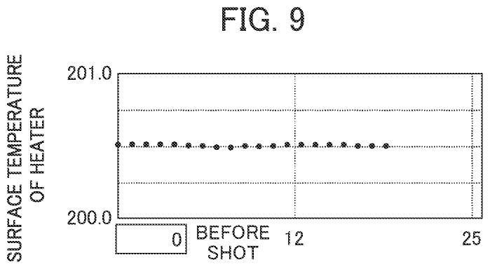

In the above-described embodiments, the output control unit 19 may cause the output unit 18 to display a scatter plot showing the surface temperature of the heater 102 according to the predetermined time, as shown in FIG. 9. With this configuration, the surface temperature of the heater 102 can be displayed in chronological order, and therefore, an abnormal surface temperature of the heater 102 can be easily monitored.

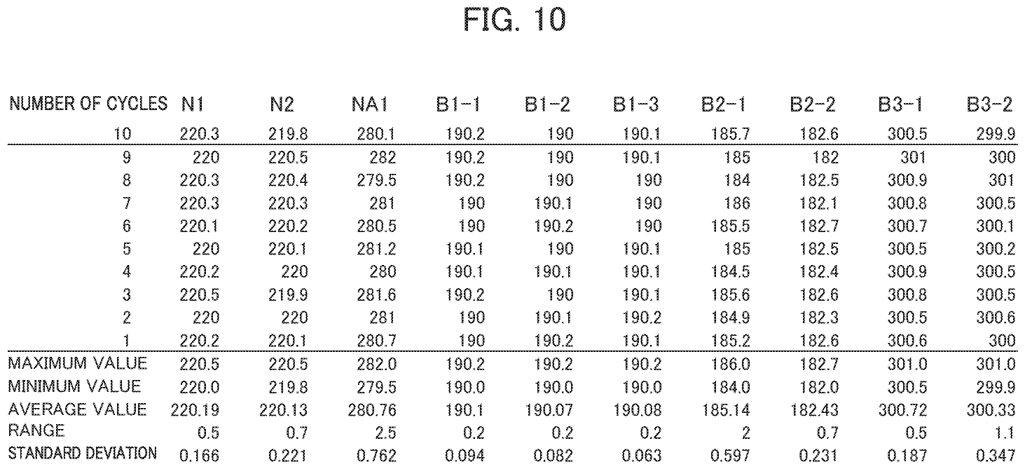

In the above-described embodiments, the output control unit 19 may cause the output unit 18 to display the list the surface temperature of the heater 102 according to the predetermined time, as shown in FIG. 10. For example, the output control unit 19 may cause the output unit 18 to display, for each heater 102, a maximum value (a temperature), a minimum value (a temperature), an average value, a difference between the maximum value and the minimum value, and a standard deviation.

In the above-described embodiments, the results information acquisition unit 14 acquires the results information, and thereafter, the operation information acquisition unit 12 acquires the operation information. However, the present disclosure is not limited to above. The operation information acquisition unit 12 may acquire the operation information before the results information acquisition unit 14 acquires the results information.

In the above-described embodiments, the injection molding machine 10 may be of an in-line screw type or a plunger type. In the above-described embodiments, the surface temperature of the heater 102 included in the results information may be one measured by a direct method using the temperature sensor (not shown) or one measured by an indirect method using thermography (a radiation thermometer, not shown).

In the above-described embodiments, the output unit 18 may be provided separate from the controller 1 (the injection molding machine 10). The controller 1 may manage a plurality of injection molding machines 10.

In the above-described embodiments, the estimation unit 17 may perform estimation at an interval of a predetermined time, such as every unit time or every cycle time. In the above-described embodiments, the estimation unit 17 may estimate an average surface temperature at a certain time interval or a surface temperature at a particular timing.

In the above-described embodiments, the operation information acquisition unit 12 may use, instead of the set temperature, a detection temperature detected at the temperature control point (or the estimated surface temperature). In the above-described embodiments, the estimation unit 17 may estimate the surface temperature of the heater 102 by taking the surface temperature of the heater 102 at the start of operation of the injection molding machine 10 as E% (E is an optional constant or variable) of the detection temperature of the heater 102 at the control point. For example, the estimation unit may estimate the surface temperature with E being a variable that E=95 holds if the detection temperature is lower than 50 degrees Celsius, and E=90 holds if the detection temperature is equal to or higher than 50 degrees Celsius.

In the above-described embodiments, the predetermined time is not limited to the current time, and may be time in the past or in the future. When the predetermined time is time in the past, the operation information acquisition unit 12 acquires a heater output and setting information in a predetermined period immediately before the predetermined time. When the predetermined time is time in the future, the operation information acquisition unit 12 acquires a heater output and setting information assumed in a predetermined period immediately before the predetermined time.

In the above-described embodiments, the surface temperature acquisition unit 15 may acquire the ratio of the surface temperature to the set temperature instead of the surface temperature. In this case, the controller 1 does not necessarily include the calculation unit 16.

### EXPLANATION OF REFERENCE NUMERALS

1 Controller

10 Injection Molding Machine

12 Operation Information Acquisition Unit

14 Results Information Acquisition Unit

15 Surface Temperature Acquisition Unit

16 Calculation Unit

17 Estimation Unit

101 Barrel

102 Heater

103 Safety Cover

1. A controller for an injection molding machine including a barrel and a heater arranged around the barrel, the controller being configured to estimate a surface temperature of the heater at a predetermined time, the controller comprising:
an operation information acquisition unit that acquires, as operation information, a heater output of the heater and a set temperature for the heater in a predetermined period immediately before the predetermined time;
a surface temperature acquisition unit that acquires the surface temperature of the heater in the predetermined period included in the acquired operation information;
a results information acquisition unit that acquires, as results information, a results of a transition in a ratio of the surface temperature of the heater to the set temperature for the heater in association with a transition in the heater output of the heater; and
an estimation unit that estimates the surface temperature of the heater at the predetermined time based on the operation information, the results information, and the acquired surface temperature.

2. The controller for the injection molding machine according to claim 1, further comprising:
a calculation unit that calculates, based on the acquired operation information and the acquired surface temperature, the transition in the ratio of the surface temperature to the set temperature in association with the transition in the heater output included in the operation information,
wherein the estimation unit estimates the surface temperature at the predetermined time by means of the operation information and a results similar to or coincident with the calculated ratio transition among results included in the results information.

3. The controller for the injection molding machine according to claim 1, wherein
the surface temperature acquisition unit acquires the surface temperature of the heater in a form of the ratio of the surface temperature of the heater to the set temperature for the heater, and
the estimation unit estimates the surface temperature at the predetermined time by means of the operation information and a results similar to or coincident with the acquired ratio transition among results included in the results information.

4. The controller for the injection molding machine according to claim 2, wherein the estimation unit estimates the surface temperature at the predetermined time from the ratio, which is indicated by the results similar to or coincident with the transition, of the surface temperature to the set temperature at a time corresponding to the predetermined time.

5. A non-transitory computer readable media which non-transitorily stores a program causing a computer to function as a controller for an injection molding machine including a barrel and a heater arranged around the barrel, the controller being configured to estimate a surface temperature of the heater at a predetermined time, the program causing
the computer to function as units comprising:
an operation information acquisition unit that acquires, as operation information, a heater output of the heater and a set temperature for the heater in a predetermined period immediately before the predetermined time,
a surface temperature acquisition unit that acquires the surface temperature of the heater in the predetermined period included in the acquired operation information,
a results information acquisition unit that acquires, as results information, a results of a transition in a ratio of the surface temperature of the heater to the set temperature for the heater in association with a transition in the heater output of the heater, and
an estimation unit that estimates the surface temperature of the heater at the predetermined time based on the operation information, the results information, and the acquired surface temperature.
